(19) United States
(12) Patent Application Publication
(10) Pub. No.: US 2023/0292112 A1
(43) Pub. Date: Sep. 14, 2023

(54) A METHOD FOR MANAGING AN AUTHENTICATION AND KEY MANAGEMENT FOR APPLICATIONS SERVICE FOR A USER EQUIPMENT

(71) Applicant: Samsung Electronics Co., Ltd., Suwon-si, Gyeonggi-do (KR)

(72) Inventors: Varini GUPTA, Bangalore (IN); Rajavelsamy RAJADURAI, Bangalore (IN); Lalith KUMAR, Bangalore (IN); Kundan TIWARI, Bangalore (IN); Rajendran ROHINI, Bangalore (IN); Nivedya Parambath SASI, Bangalore (IN)

(21) Appl. No.: 18/017,008

(22) PCT Filed: Jul. 20, 2021
(86) PCT No.: PCT/KR2021/009349

§ 371 Date: Jan. 19, 2023

(30) Foreign Application Priority Data
Jul. 21, 2020 (IN) 202041031188
Jul. 13, 2021 (IN) 202041031188

(51) Int. Cl. H04W 12/04

(52) U.S. Cl. CPC H04W 12/04

(57) ABSTRACT

The present disclosure realtes to a pre-5th generation (5G) or 5G communication system to be provided for supporting higher data rates beyond 4th-generation (4G) communication system such as long term evolution (LTE). In an embodiment, a method, for managing an Authentication and Key Management for Applications (AKMA) service for a User Equipment (UE) in a communication system is disclosed. The method includes determining, by a network function, that the UE is not allowed to utilize the AKMA service, in response to detecting at least one condition associated with the UE. The method includes transmitting, by the network function, a request to an AKMA Anchor Function (AAnF) for deleting an AKMA context corresponding to the UE from a memory associated with the AAnF. The method includes deleting, by the AAnF, the AKMA context corresponding to the UE from the memory.

### TECHNICAL FIELD

The present disclosure, in general, relates to network procedures performed by User Equipment (UE), and, in particular, relates to systems and methods for managing an Authentication and Key Management for Applications (AKMA) service for a user equipment.

### BACKGROUND ART

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’.

The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems.

In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like.

In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

### DISCLOSURE OF INVENTION

### Technical Problem

When a network operator deploys AKMA functionality, K_{AF} key material is used for protecting the communication between UE and AF, and is derived from K_{AKMA}. K_{AKMA} is generally valid for unlimited lifetime (or until next Primary Authentication when new K_{AUSF}, K_{AKMA} and A-KID will be generated), while K_{AF} is valid for a limited lifetime. Upon expiry of K_{AF}, UE and AF may request to refresh K_{AF}.

Since K_{AF} is stored in the ME, a malicious ME can continue to use the K_{AF} long after UE deregistration, and thus continue to access the application it is not authorized to use. Even if K_{AF} expires, AF can request a key refresh from AAnF. Since AAnF has no information as to whether UE has been purged from the network, it will allow refresh and/or generation of K_{AF} and the unauthorized use of application may continue.

Refresh of keys by 3gpp network gives an impression to third party application provider that UE is still present in the network and is authorized to use the application. This not only results in billing issues, but also diminishes the credibility of the AKMA framework. Same issue happens when UE's authentication fails, or SMC failure happens leading to removal of the UE from the network. Same issue happens when AKMA subscription is withdrawn for the user.

Thus, there is a need for a solution that overcomes the above deficiencies.

### Solution to Problem

This summary is provided to introduce a selection of concepts, in a simplified format, that are further described in the detailed description of the invention. This summary is neither intended to identify key or essential inventive concepts of the invention and nor is it intended for determining the scope of the invention.

In accordance with some example embodiments of the present subject matter, a method, for managing an Authentication and Key Management for Applications (AKMA) service for a User Equipment (UE) in a communication system is disclosed. The method includes determining, by a network function, that the UE is not allowed to utilize the AKMA service, in response to detecting at least one condition associated with the UE. The method includes transmitting, by the network function, a request to an AKMA Anchor Function (AAnF) for deleting an AKMA context corresponding to the UE from a memory associated with the AAnF. The method includes deleting, by the AAnF, the AKMA context corresponding to the UE from the memory.

In accordance with some example embodiments of the present subject matter, a method, for managing an Authentication key (K_{AF}) for a User Equipment (UE) in a communication system is disclosed. The method includes detecting, by a network function, a connection status between the UE and a network. The method includes determining, by the network function, that the K_{AF} is not sharable with the AF in response to determining the connection status of the UE. The method includes deleting, by an Authentication and Key Management for Applications Anchor Function (AAnF), the K_{AKMA} from a memory in response to determining that the K_{AF} is not sharable with the AF.

In accordance with some example embodiments of the present subject matter, a system, for managing an Authentication and Key Management for Applications (AKMA) service for a User Equipment (UE) in a communication system is disclosed. The system includes a network function configured to determine that the UE is not allowed to utilize the AKMA service, in response to detecting at least one condition associated with the UE. The network function is further configured to transmit a request to an AKMA Anchor Function (AAnF) for deleting an AKMA context corresponding to the UE from a memory associated with the AAnF. The system includes the AAnF configured to delete the AKMA context corresponding to the UE from the memory.

In accordance with some example embodiments of the present subject matter, a system for managing an Authentication key (K_{AF}) for a User Equipment (UE) in a communication system is disclosed. The system includes a network function configured to detect a connection status between the UE and a network. The network function is further configured to determine that the K_{AF} is not sharable with the AF in response to determining the connection status of the UE. The system includes an Authentication and Key Management for Applications Anchor Function (AAnF) configured to delete the K_{AKMA} from a memory in response to determining that the K_{AF} is not sharable with the AF.

To further clarify advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### Advantageous Effects of Invention

According to the disclosure, there is improvements in and relating to managing an authentication and key management for applications (AKMA) service for a user equipment (UE) in a communication system.

### BRIEF DESCRIPTION OF DRAWINGS

These and other features, aspects, and advantages of the present invention will become better understood when the following detailed description is read with reference to the accompanying drawings in which like characters represent like parts throughout the drawings, wherein:

FIG. 1 illustrates a schematic block diagram depicting a method for managing an Authentication and Key Management for Applications (AKMA) service for a User Equipment (UE) in a communication system, in accordance with embodiment of the present subject matter;

FIG. 2 illustrates a schematic block diagram of a system for managing an AKMA service for a UE in a communication system, in accordance with an embodiment of the present subject matter;

FIG. 3 illustrates an operational flow diagram depicting a process for deleting an AKMA context related to a UE by an AUSF acting as a network function, in accordance with an embodiment of the present subject matter;

FIG. 4 illustrates an operational flow diagram depicting a process for deleting an AKMA context related to a UE by an AUSF based on an UDM instruction, in accordance with an embodiment of the present subject matter;

FIG. 5 illustrates an operational flow diagram depicting a process for an AAnF subscribing to a UDM for receiving notifications related to UE deregistration events, in accordance with an embodiment of the present subject matter;

FIG. 6 illustrates an operational flow diagram depicting a process for an UDM to notify an AAnF to delete an AKMA context related to a UE, in accordance with an embodiment of the present subject matter; and

FIG. 7 illustrates a schematic block diagram depicting a method for managing an Authentication key (K_{AF}) for a User Equipment (UE) in a communication system, in accordance with embodiment of the present subject matter.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### MODE FOR THE INVENTION

For promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skilled in the art to which this invention belongs. The system, methods, and examples provided herein are illustrative only and not intended to be limiting.

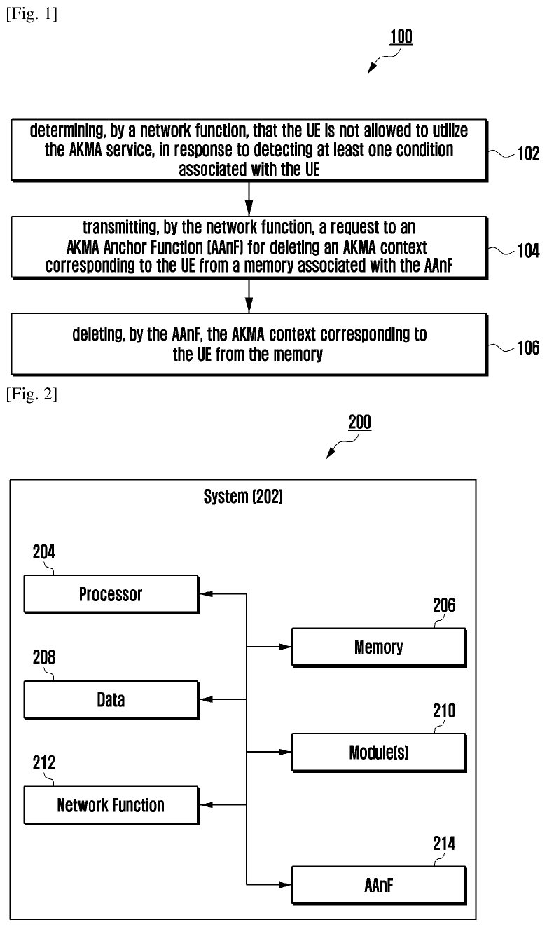

FIG. 1 illustrates a schematic block diagram 100 depicting a method for managing an AKMA service for a UE in a communication system, in accordance with embodiment of the present subject matter. In an embodiment, the AKMA service is managed by an AKMA Anchor Function.

According to an embodiment of the present subject matter, the method includes determining (step 102) by a network function, that the UE is not allowed to utilize the AKMA service, in response to detecting at least one condition associated with the UE.

Continuing with the above embodiment, the method includes transmitting (step 104) by the network function, a request to an AKMA Anchor Function (AAnF) for deleting an AKMA context corresponding to the UE from a memory associated with the AAnF.

Moving forward, the method includes deleting (step 106) by the AAnF, the AKMA context corresponding to the UE from the memory.

FIG. 2 illustrates a schematic block diagram 200 of a system 202 for managing an AKMA service for a UE in a communication system, in accordance with an embodiment of the present subject matter. In an embodiment, the system 202 may be configured to prevent the UE from accessing a third-party application on a network upon being disconnected from the network. In an embodiment, the system 202 may be configured to delete an AKMA context associated with the UE based on at least one condition. The AKMA context may include a SUPI, an AKMA anchor key (K_{AKMA}), and an AKMA Key Identifier (A-KID) related to the UE. The K_{AKMA} may be derived from a key K_{AUSF}.

Continuing with the above embodiment, the system 202 may include a processor 204, a memory 206, data 208, module(s) 210, a network function 212, and an AKMA Anchor Function (AAnF) 214. In an embodiment, the processor 204, the memory 206, the data 208, the module(s) 210, the network function 212, and the AAnF 214 may be communicably coupled to one another.

As would be appreciated, the system 202, may be understood as one or more of a hardware, a software, a logic-based program, a configurable hardware, and the like. In an example, the processor 204 may be a single processing unit or a number of units, all of which could include multiple computing units. The processor may be implemented as one or more microprocessors, microcomputers, microcontrollers, digital signal processors, central processing units, processor cores, multi-core processors, multiprocessors, state machines, logic circuitries, application-specific integrated circuits, field-programmable gate arrays and/or any devices that manipulate signals based on operational instructions. Among other capabilities, the processor 204 may be configured to fetch and/or execute computer-readable instructions and/or data 208 stored in the memory 206.

In an example, the memory 206 may include any non-transitory computer-readable medium known in the art including, for example, volatile memory, such as static random access memory (SRAM) and/or dynamic random access memory (DRAM), and/or non-volatile memory, such as read-only memory (ROM), erasable programmable ROM (EPROM), flash memory, hard disks, optical disks, and/or magnetic tapes. The memory 206 may include the data 208.

The data 208 serves, amongst other things, as a repository for storing data processed, received, and generated by one or more of, the processor 204, the memory 206, the module(s) 210, the network function 212, and the AAnF 214. In an embodiment, the data 208 may include the AKMA context associated with the UE.

The module(s) 210, amongst other things, may include routines, programs, objects, components, data structures, etc., which perform particular tasks or implement data types. The module(s) 210 may also be implemented as, signal processor(s), state machine(s), logic circuitries, and/or any other device or component that manipulate signals based on operational instructions.

Further, the module(s) 210 may be implemented in hardware, instructions executed by at least one processing unit, for e.g., processor 204, or by a combination thereof. The processing unit may be a general-purpose processor which executes instructions to cause the general-purpose processor to perform operations or, the processing unit may be dedicated to performing the required functions. In another aspect of the present disclosure, the module(s) 210 may be machine-readable instructions (software) which, when executed by a processor/processing unit, may perform any of the described functionalities.

In some example embodiments, the module(s) 210 may be machine-readable instructions (software) which, when executed by a processor/processing unit, perform any of the described functionalities.

Continuing with the above embodiment, the network function 212 may be one of an Access and Mobility Management Function (AMF), a Unified Data Management (UDM), and an Authentication Server Function (AUSF). In an embodiment, the network function 212 may be configured to determine that the UE is not allowed to utilize the AKMA service in response to detecting the at least one condition associated with the UE. In an embodiment, the at least one condition may indicate one of the UE is disconnected from the network, and an AKMA subscription associated with the UE is withdrawn.

Subsequent to determining that the UE is not allowed to utilize the AKMA service, the network function 212 may be configured to transmit a request to the AAnF 214. In an embodiment, the request may correspond to deleting one or more of the AKMA context corresponding to the UE and a security context in the AUSF and the AKMA context corresponding to the UE. In an embodiment, the AKMA context may be stored in the memory 206 in the system 202 related to the AAnF 214.

In an embodiment, where the network function 212 is the AMF, the network 212 may be configured to initiate a result removal procedure towards the AUSF in response to determining that the UE is disconnected from the network. In an embodiment, the result removal procedure may correspond to deleting the AKMA context. Furthermore, upon initiation of the result removal procedure, the AUSF may be configured to transmit the request to the AAnF 214 for deleting the AKMA context corresponding to the UE. In an embodiment, the request to delete the AKMA context related to the UE may be transmitted by the UDM. In an embodiment, transmitting the request by one or more of the AUSF and the UDM may be based on one or more of a key deregistration service and a key deregistration service operation. In an embodiment, the key deregistration service and the key deregistration service operation may be specified by the AAnF 214.

According to an embodiment of the present subject matter, the UDM may be configured to transmit the request to the AUSF for deleting the AKMA context. Moving forward, upon receiving the request, the AUSF may be configured to transmit the request to the AAnF 214. In an embodiment, the UDM may be configured to transmit the request to delete the AKMA context to the AAnF 214.

According to an embodiment of the present subject matter, the AMF may be configured to determining a de-registration of the UE from the network. Moving forward, the AMF may be configured to inform the UDM to purge the UE from the network upon determining the de-registration of the UE from the network. In response to being informed, the UDM may be configured to transmit a notification to the AAnF indicating the de-registration of the UE from the network.

In an embodiment, UDM may be configured to transmit the request to AUSF for deleting the AKMA context, upon determining that the AKMA subscription associated with the UE is withdrawn.

In an embodiment, the AAnF 214 may be configured to subscribe to the UDM for receiving the notification indicating one or more of the de-registration of the UE from the network and a withdrawal of the AKMA subscription associated with the UE by providing the callback address and the SUPI associated with the UE.

In continuation with the above embodiment, the AAnF 214 may be configured to delete the AKMA context corresponding to the UE from the memory 206. In an embodiment, the AAnF 214 may be configured to transmit a notification to an Application Function (AF) on a callback URI indicating that the AKMA context corresponding to the UE is deleted. In an embodiment, deleting the AKMA context related to the UE may resulting in an invalidation of an AKMA application key (K_{AF}) by the AF.

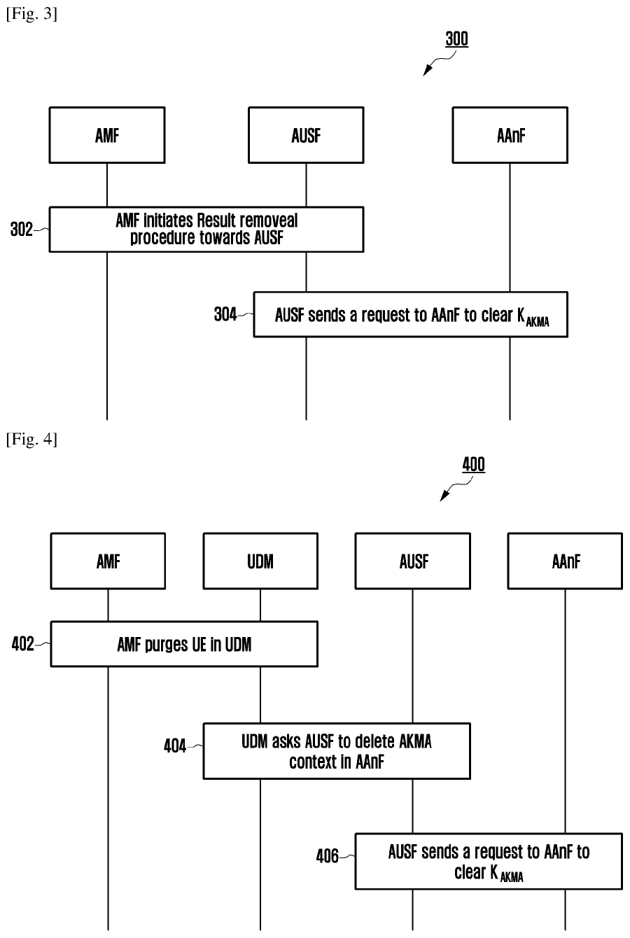

FIG. 3 illustrates an operational flow diagram 300 depicting a process for deleting an AKMA context related to a UE by an AUSF acting as the network function 212, in accordance with an embodiment of the present subject matter. In an embodiment, the AKMA context may deleted from the memory 206 to prevent the UE from accessing a third-party application on a network. In an embodiment, the AKMA context may include a SUPI, an AKMA anchor key (K_{AKMA}), and an AKMA Key Identifier (A-KID) related to the UE. In an embodiment, the UE is prevented to access the third-party application upon being disconnected to the network. In an embodiment, the UE is prevented to access the third-party application upon an expiration of an AKMA subscription related to the UE. In an embodiment, the UE is purged from the network upon being disconnected to the network. In an embodiment, a UE context may be removed from the network in response to a failure of a Security Management Centre (SMC) procedure associated with the UE.

Continuing with the above embodiment of the present subject matter, the process may include initiating (step 302) a result removal procedure towards an AUSF. In an embodiment, the result removal procedure may be initiated by the network function 212 as referred in the FIG. 2. In an embodiment, the network function 212 may be an AMF.

In response to initiation of the result removal procedure towards the AUSF, the process may include transmitting (step 304) a request to the AAnF 214 as referred in the FIG. 2 to delete the AKMA context containing, one or more AKMA keys of the SUPI (UE) removed from the network. In an embodiment, the process may include specifying by the AAnF 214 a new service allowing NF service consumers such as the AUSF, and the UDM to transmit the request to clean-up the AKMA context for the SUPI (UE). In an embodiment, the new service may be a key deregistration service (Naanf_AKMA_KeyDeregistration Service). In an embodiment, the request may allow a POST, PUT or DELETE operation. Following is an example of a definition of the key deregistration service:

Service Name: Naanf_AKMA_KeyDeregistration

Service operation name: Naanf_AKMA_KeyDeregistration_deregister

Description: The NF consumer (UDM, AUSF) requests the AAnf to delete the AKMA context.

Input, Required: SUPI

Input, Optional: None

Output, Required: None

Output, Optional: None

In an embodiment, the process may include specifying by the AAnF 214 a new service operation in an AAnF key management service such as a deregister operation under one or more of the Naanf_AKMA_KeyRegistration, Naanf_AKMA_KeyManagement). In an embodiment, the deregistration operation may be configured to allows the AUSF, and the UDM to transmit the request to clean-up the AKMA context for the SUPI (UE). In an embodiment, the request may utilize the POST, PUT or DELETE operation. Following is an example of a definition of such the service:

Service Name: Naanf_AKMA_KeyRegistration (or Naanf_AKMA_KeyManagement)

Service operation name: Naanf_AKMA_KeyRegistration_deregister (or Naanf_AKMA_KeyManagement_deregister)

Description: The NF consumer (AUSF, UDM) may be configured to request the AAnf to delete the AKMA context.

Input, Required: SUPI

Input, Optional: None

Output, Required: None

Output, Optional: None

In an embodiment, the AUSF may be configured to store an identity associated with the AAnF 214 with the UE context. In an embodiment, prior to deletion of the UE context by the AUSF, the AUSF may be configured to identify the AAnF 214 and transmit the request for the AKMA context deletion. Furthermore, the process may include deleting by the AAnF 214 the AKMA context related to the UE. In an embodiment, where it is determined that the AKMA context in the AAnF 214 is deleted, the K_{AF} may not be refreshed further using the A-KID.

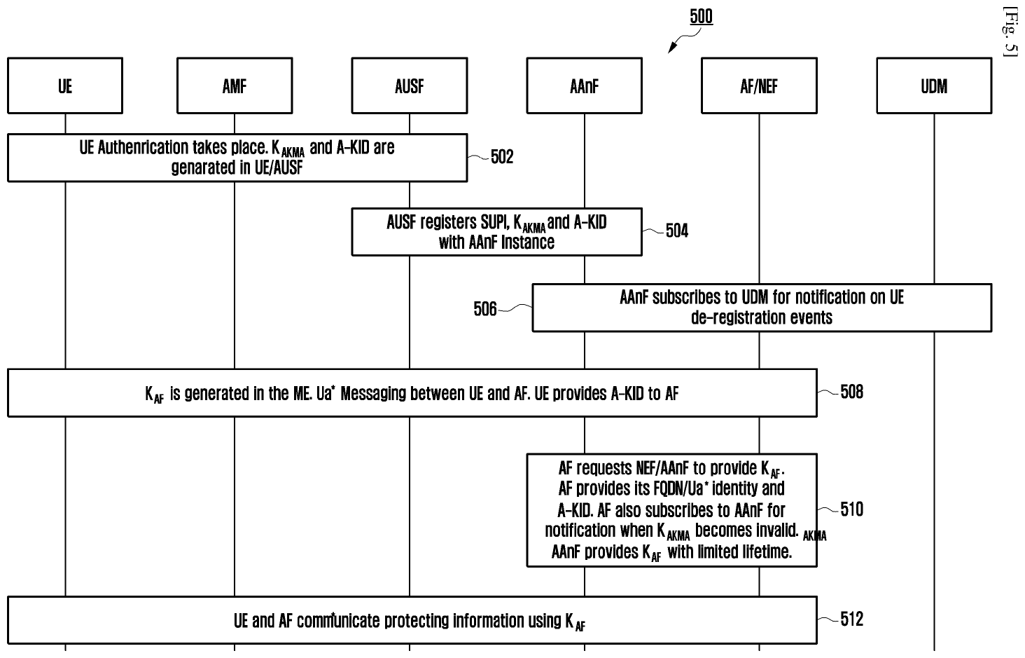

FIG. 4 illustrates an operational flow diagram 400 depicting a process for deleting an AKMA context related to a UE by an AUSF based on an UDM instruction, in accordance with an embodiment of the present subject matter. In an embodiment, the UDM, and the AUSF, and an AMF may be the network function 212 as referred in the FIG. 2. In an embodiment, the UE is purged from the network upon being disconnected to the network. In an embodiment, a UE context may be removed from the network in response to a failure of an SMC procedure associated with the UE.

Continuing with the above embodiment of the present subject matter, the process may include initiating (step 402) a purge notification procedure towards the UDM. In an embodiment, the purge notification procedure may be initiated by the AMF.

In response to initiation of the purge notification procedure towards the UDM, the process may include transmitting (step 404) a request to the AUSF by the UDM to delete the AKMA context containing, one or more AKMA keys of the SUPI (UE) purged from the network. In an embodiment, the process may include indicating by the UDM, to the AUSF to clear the AKMA context in response to the UDM determining that the UDM is deleting a latest K_{AUSF}. In an embodiment, the K_{AUSF} may be a key utilized by the UE and the AUSF for deriving a key for the AAnF 214 also referred as an K_{AKMA} In an embodiment, the process may include enhancing a deregister service operation in a Nausf_UEAuthentication service to include an “AKMA” indication. In an embodiment, the UDM may include an indication determining to delete one or more of the AKMA context in AAnF, and the AKMA context and a security context in the AUSF.

Continuing with the above embodiment, the process may include initiating (step 406) by the AUSF a cleaning-up of the AKMA context in an embodiment where the “AKMA” indication is included in deregister service operation. In an embodiment, initiating the cleaning-up of the AKMA context may include transmitting a request from the AUSF to the AAnF 214 as referred in the FIG. 2 for deleting the AKMA context related to the UE disconnected from the network. Further, the process may include deleting by the AAnF 214, the AKMA context related to the UE.

In an embodiment, the process may include specifying by the AAnF 214 a new service allowing NF service consumers such as the AUSF, and the UDM to transmit the request to clean-up the AKMA context for the SUPI (UE). In an embodiment, the new service may be a key deregistration service (Naanf_AKMA_KeyDeregistration Service). In an embodiment, the request may allow a POST, PUT or DELETE operation. Following is an example of a definition of the key deregistration service:

Service Name: Naanf_AKMA_KeyDeregistration

Service operation name: Naanf_AKMA_KeyDeregistration_deregister

Description: The NF consumer (UDM, AUSF) requests the AAnf to delete the AKMA context.

Input, Required: SUPI

Input, Optional: None

Output, Required: None

Output, Optional: None

In an embodiment, the process may include specifying by the AAnF 214 a new service operation in an AAnF key management service such as a deregister operation under one or more of the Naanf_AKMA_KeyRegistration, Naanf_AKMA_KeyManagement). In an embodiment, the deregistration operation may be configured to allows the AUSF, and the UDM to transmit the request to clean-up the AKMA context for the SUPI (UE). In an embodiment, the request may utilize the POST, PUT or DELETE operation. Following is an example of a definition of such the service:

Service Name: Naanf_AKMA_KeyRegistration (or Naanf_AKMA_KeyManagement)

Service operation name: Naanf_AKMA_KeyRegistration_deregister (or Naanf_AKMA_KeyManagement_deregister)

Description: The NF consumer (AUSF, UDM) may be configured to request the AAnf to delete the AKMA context.

Input, Required: SUPI

Input, Optional: None

Output, Required: None

Output, Optional: None

In an embodiment, the AUSF may be configured to store an identity associated with the AAnF 214 with the UE context. In an embodiment, prior to deletion of the UE context by the AUSF, the AUSF may be configured to identify the AAnF 214 and transmit the request for the AKMA context deletion. Furthermore, the process may include deleting by the AAnF 214 the AKMA context related to the UE. In an embodiment, where it is determined that the AKMA context is the AAnF 214 is deleted, the K_{AF} may not be refreshed further using the A-KID.

In an alternative embodiment, the process may include transmitting the request from the UDM to the AAnF 214 to delete the AKMA context containing one or more AKMA keys for the SUPI (UE) based on the deregistration service and the deregistration service operation described above. In an embodiment, the UDM may be configured to delete the AKMA context upon deciding to delete the latest K_{AUSF}. In an embodiment, one or more of the UDM, and the AUSF may be configured to delete the AKMA context when the UE is not purged or a UE 5G security context also referred as the UE security context is active and the UE is in a registered state when AKMA subscription data indicating a subscription of an AMA service is discontinued.

FIG. 5 illustrates an operational flow diagram 500 depicting a process for the AAnF 214 subscribing to a UDM for receiving notifications related to UE deregistration events, in accordance with an embodiment of the present subject matter. In an embodiment, the UDM may the network function 212 as referred in the FIG. 2.

In an embodiment, the process may include authenticating (step 502), a UE in the network. In an embodiment, where it is determined that the UE includes an AKMA subscription, the process may proceed towards generating a K_{AKMA} and a A-KID related to the UE. In an embodiment, the K_{AKMA} and the A-KID may be generated by the UE and the AUSF.

Continuing with the above embodiment, the process may proceed towards selecting (step 504) by the AUSF an AAnF instance to serve the UE. Following the selection of the AAnF instance, the process may proceed towards registering a SUPI, the K_{AKMA} and the A-KID at the AAnF 214 as referred in the FIG. 2

Moving forward, the process may include subscribing (step 506) by the AAnF 214 to UDM for receiving notification related to the UE de-registration events. In an embodiment, the AAnF 214 may subscribe to the UDM by providing a callback address and the SUPI related to the UE. In an embodiment, the AAnF 214 may select a UDM instance by querying a Network Repository Function (NRF). In an embodiment, the UDM may be the network function 212 as referred in the FIG. 2.

Subsequently, the process may proceed towards, generating (step 508) by the UE a K_{AF} from the K_{AKMA} and an AF identity such as a FQDN pre-configured in the UE by a third party application. Further, the UE may initiate a Ua* messaging with the AF and provide the A-KID to the AF.

Moving forward, the process may include transmitting (step 510) a request to AAnF 214 by the AF for provide K_{AF} corresponding to the A-KID received from the UE. In an embodiment, the request may include the AF identity. In an embodiment, one of the AF and Network Exposure Function (NEF) may also include the callback address for transmitting back the notifications. In an embodiment, the notification may be related to events such as a K_{AKMA} becoming invalid due to the UE de-registration/purge from the network.

In an embodiment, the process may include providing (step 512) the K_{AF} to the AF with a limited time period of validity. In an embodiment, the K_{AF} may be provided by the AAnF 214.

Continuing with the above embodiment, the process may include transmitting (step 514) information by the UE and the AF between one another using the K_{AF} for protecting a communication between the UE and the AF.

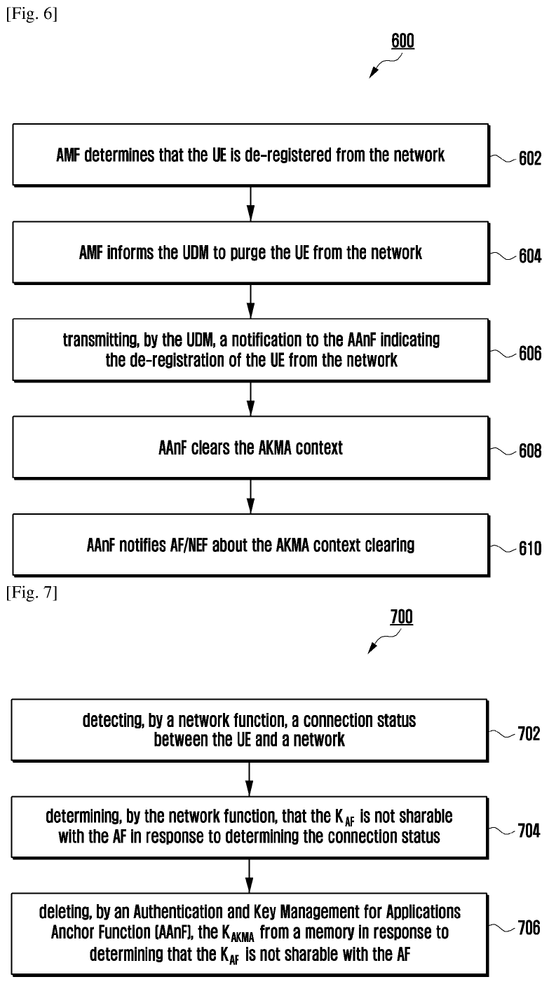

FIG. 6 illustrates an operational flow diagram 600 depicting a process for a UDM to notify the AAnF 214 to delete an AKMA context related to a UE, in accordance with an embodiment of the present subject matter. In an embodiment, the UDM may the network function 212 as referred in the FIG. 2.

In an embodiment, the process may include determining (step 602) by an AMF that the UE is de-registered from the network.

Continuing with the above embodiment, the process may include informing (step 604) by the AMF the UDM to purge the UE from the network.

In an embodiment, the process may proceed towards transmitting (step 606) a notification to the AAnF 214 indicating the de-registration of the UE from the network. Moving forward, the process may include deleting (step 608), by the AAnF 214, the AKMA context corresponding to the UE in response to being notified about the de-registration of the UE from the network.

Furthermore, the process may include notifying (step 610) by the AAnF, the AF/NEF that the AKMA context corresponding to the UE is deleted. In an embodiment, the notification to the AF may be transmitted on a callback URI indicating that the AKMA context corresponding to the UE is deleted resulting in invalidation of an AKMA application key (K_{AF}) by the AF. In an embodiment, the K_{AF} may generated from the K AKMA by the UE.

In an embodiment, the AAnF 214 may subscribe for deletion of the KAUSF and the AUSF may notify the AAnF 214 upon deleting the KAUSF. In an embodiment, the AAnF 214 may store a latest AUSF instance ID that transmitted the AKMA key and the A-KID and deletes the AKMA context. In an embodiment, the AKMA context may deleted if the notifying AUSF instance ID matches with the stored AUSF instance ID.

FIG. 7 illustrates a schematic block diagram 700 depicting a method for managing an Authentication key (K_{AF}) for a User Equipment (UE) in a communication system, in accordance with embodiment of the present subject matter. In an embodiment, the AKMA service is managed by an AKMA Anchor Function.

According to an embodiment of the present subject matter, the method includes detecting (step 702) by a network function, a connection status between the UE and a network.

In continuation with the above embodiment, the method may include determining (step 704), by the network function, that the K_{AF} is not sharable with the AF in response to determining the connection status. Furthermore, the method may proceed towards deleting (step 706) deleting, by an AAnF, the K_{AKMA} from a memory in response to determining that the K_{AF} is not sharable with the AF.

The disclosure is not restricted to the details of the foregoing embodiment(s). The disclosure extends to any novel one, or any novel combination, of the features disclosed in this specification (including any accompanying claims, abstract and drawings), or to any novel one, or any novel combination, of the steps of any method or process so disclosed.

In the above-described detailed embodiments of the disclosure, the elements included in the disclosure may be expressed in the singular or plural form depending on the proposed detailed embodiment. However, the singular or plural expression has been selected suitably for a situation proposed for convenience of description, and the disclosure is not limited to the singular or plural elements. Although an element has been expressed in the plural form, it may be configured in the singular form. Although an element has been expressed in the singular form, it may be configured in the plural form. The embodiments described in this specification have been individually described, but two or more of the embodiments may be combined and practiced.

Although the detailed embodiments have been described in the detailed description of the disclosure, the disclosure may be modified in various ways without departing from the scope of the disclosure. Accordingly, the scope of the disclosure should not be limited to the above-described embodiments, but should be defined by not only the claims, but equivalents thereof.

The embodiments of the disclosure and the terms used in the embodiments are not intended to limit the technology described in this document to a specific embodiment, but should be construed as including various changes, equivalents and/or alternatives of a corresponding embodiment. Regarding the description of the drawings, similar reference numerals may be used in similar elements. An expression of the singular number may include an expression of the plural number unless clearly defined otherwise in the context. In this document, an expression, such as “A or B”, “at least one of A or/and B”, “A, B or C” or “at least one of A, B and/or C”, may include all of possible combinations of listed items together. Expressions, such as “a first,” “a second,” “the first” and “the second”, may modify corresponding elements regardless of the sequence and/or importance, and are used to only distinguish one element from the other element and do not limit corresponding elements. When it is described that one (e.g., first) element is “(operatively or communicatively) connected to” or “coupled with” the other (e.g., second) element, one element may be directly connected to the other element or may be connected to the other element through another element (e.g., third element).

While specific language has been used to describe the present disclosure, any limitations arising on account thereto, are not intended. As would be apparent to a person in the art, various working modifications may be made to the method to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

1. A method for managing an Authentication and Key Management for Applications (AKMA) service for a User Equipment (UE) in a communication system, the method comprising:
determining, by a network function, that the UE is not allowed to utilize the AKMA service, in response to detecting at least one condition associated with the UE;
transmitting, by the network function, a request to an AKMA Anchor Function (AAnF) for deleting an AKMA context corresponding to the UE from a memory associated with the AAnF; and
deleting, by the AAnF, the AKMA context corresponding to the UE from the memory.

2. The method as claimed in claim 1, wherein the network function is one of an Access and Mobility Management Function (AMF), a Unified Data Management (UDM), and an Authentication Server Function (AUSF).

3. The method as claimed in claim 1, wherein the AKMA context comprises a SUPI, an AKMA anchor key (K_{AKMA}), and an AKMA Key Identifier (A-KID).

4. The method as claimed in claim 1, wherein the at least one condition associated with the UE is one of:
a) The UE is disconnected from the network; and
b) An AKMA subscription associated with the UE is withdrawn.

5. The method as claimed in claims 1 & 2, wherein transmitting the request to the AAnF comprising:
initiating, by the AMF, a result removal procedure towards the AUSF in response to determining that the UE is disconnected from the network; and
transmitting, by the AUSF, the request to the AAnF for deleting the AKMA context corresponding to the UE disconnected from the network.
deleting, by the AAnF, the AKMA context corresponding to the UE disconnected from the network.

6. The method as claimed in claims 1 & 5, wherein the request is transmitted by one or more of the AUSF, and the UDM based on a key deregistration service specified by the AAnF.

7. The method as claimed in claims 1 & 5, wherein the request is transmitted by one or more of the AUSF, and the UDM based on a key deregistration service operation specified by the AAnF.

8. The method as claimed in claims 1 & 2, wherein transmitting the request to the AAnF comprising:
initiating, by the AMF, a purge request towards the UDM in response to determining that the UE is disconnected from the network;
transmitting, by the UDM, the request to the AUSF for deleting the AKMA context corresponding to the UE disconnected from the network;
transmitting, by the AUSF, the request to the AAnF for deleting the AKMA context corresponding to the UE disconnected from the network.
deleting, by the AAnF, the AKMA context corresponding to the UE disconnected from the network.

9. The method as claimed in claim 8, wherein the request comprises an indication to delete one or more of:
the AKMA context corresponding to the UE; and
a security context in the AUSF and the AKMA context corresponding to the UE.

10. The method as claimed in claim 8, wherein the UDM transmits the request to delete the AKMA context corresponding to the UE to the AAnF.

11. The method as claimed in claims 1 & 2, wherein transmitting the request to the AAnF comprising:
informing, by the AMF, to the UDM for purging the UE from the network, in response to determining a de-registration of the UE from the network;
transmitting, by the UDM, a notification to the AAnF indicating the deregistration of the UE from the network; and
deleting, by the AAnF, the AKMA context corresponding to the UE in response to being notified about the de-registration of the UE from the network.

12. The method as claimed in claim 11, further comprising:
transmitting, by the AAnF, a notification to the AF on a callback URI indicating that the AKMA context corresponding to the UE is deleted resulting in invalidation of an AKMA application key (K_{AF}) by the AF, wherein the K_{AF} is generated from the AKMA by the UE.

13. The method as claimed in claim 11, wherein the AAnF subscribes to the UDM for receiving the notification indicating one or more the deregistration of the UE from the network and a withdrawal of the AKMA subscription associated with the UE, by providing the callback address and the SUPI associated with the UE.

14. A method for managing an Authentication key (K_{AF}) for a User Equipment (UE) in a communication system, the method comprising:
detecting, by a network function, a connection status between the UE and a network;
determining, by the network function, that the K_{AF} is not sharable with the AF in response to determining the connection status of the UE; and
deleting, by an Authentication and Key Management for Applications Anchor Function (AAnF), the K_{AKMA} from a memory in response to determining that the K_{AF} is not sharable with the AF.

15. A system for managing an Authentication and Key Management for Applications (AKMA) service for a User Equipment (UE) in a communication system, the system comprising:
a network function configured to:
determine that the UE is not allowed to utilize the AKMA service, in response to detecting at least one condition associated with the UE;
transmit a request to an AKMA Anchor Function (AAnF) for deleting an AKMA context corresponding to the UE from a memory associated with the AAnF; and
the AAnF configured to delete the AKMA context corresponding to the UE from the memory.
